(19) United States
(12) Patent Application Publication
(10) Pub. No.: US 2026/0093652 A1
(43) Pub. Date: Apr. 2, 2026

(54) SIGNAL TRANSMITTER BASED ON UNIVERSAL SERIAL BUS PROTOCOL AND HANDSHAKE METHOD THEREOF

(71) Applicant: SigmaStar Technology Ltd., Xiamen (CN)

(72) Inventors: Sixin HONG, Shanghai (CN); Zhenyang PANG, Shanghai (CN); Tianli QU, Shanghai (CN)

(21) Appl. No.: 19/317,454

(22) Filed: Sep. 3, 2025

(30) Foreign Application Priority Data
Sep. 27, 2024 (CN) 202411365107.6

(51) Int. Cl. G06F 13/38; G06F 13/42

(52) U.S. Cl. CPC G06F 13/382; G06F 13/4282

(57) ABSTRACT

A signal transmitter includes a driving circuit, a control circuit and a clamping circuit. The driving circuit adjusts a level of a signal pad according to a data signal during a handshake phase to perform a speed negotiation with an electronic device. The control circuit generates a clamping signal according to an operation mode signal and a transmit valid signal in a Universal Serial Bus (USB) protocol. The clamping circuit is activated according to the clamping signal during the handshake phase to limit the level of the signal pad.

This application claims the benefit of China application Serial No. CN202411365107.6, filed on September 27, 2024, the subject matter of which is incorporated herein by reference.

### BACKGROUND OF THE INVENTION

### Field of the Invention

The present application relates to a signal transmitter, and more particularly to a signal transmitter able to provide voltage protection during a handshake phase and a handshake method thereof.

### Description of the Related Art

Universal Serial Bus (USB) is often applied in various electronic devices to perform data transmission with one another. Before data transmission is performed, a host device, based on a USB protocol, handshakes with the terminal device to determine a transmission speed supported by both devices. In current electronic devices, due to influences of process variations, resistance values of resistance and/or transistors may be changed to lead to an overly increase in a level of a signal pad or a pin during a handshake phase, resulting in errors in the speed negotiation.

### SUMMARY OF THE INVENTION

In some embodiments, it is an object of the present application to provide a signal transmitter able to provide voltage protection during a handshake phase and a handshake method thereof, so as to improve the issues of the prior art.

In some embodiments, a signal transmitter includes a driving circuit, a control circuit and a clamping circuit. The driving circuit adjusts a level of a signal pad according to a data signal during a handshake phase to perform a speed negotiation with an electronic device. The control circuit generates a clamping signal according to an operation mode signal and a transmit valid signal in a Universal Serial Bus (USB) protocol. The clamping circuit is activated according to the clamping signal during the handshake phase to limit the level of the signal pad.

In some embodiments, a handshake method performed by a signal transmitter includes operations of: during a handshake phase, adjusting a level of a signal pad according to a data signal to perform a speed negotiation with an electronic device; generating a clamping signal according to an operation mode signal and a transmit valid signal in a Universal Serial Bus (USB) protocol; and activating a clamping circuit in the signal transmitter according to the clamping signal in the handshake phase to limit the level of the signal pad by the clamping circuit.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 shows a schematic diagram of a signal transmitter according to some embodiments of the present application.

FIG. 2 shows a schematic diagram of the control circuit in FIG. 1 according to an embodiment of the present application.

FIG. 3 shows a schematic diagram of operation timings of the clamping signal and the operation mode signal as well as line statuses between the signal transmitter and the electronic device according to some embodiments of the present application.

FIG. 4 shows an operation flowchart of a handshake method according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

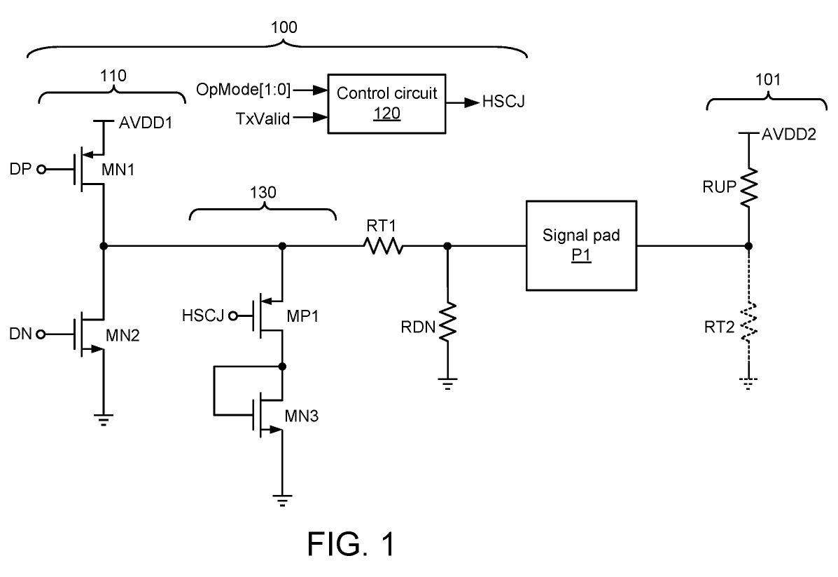

FIG. 1 shows a schematic diagram of a signal transmitter 100 according to some embodiments of the present application. In some embodiments, the signal transmitter 100 is applicable to a host device using the Universal Serial Bus (USB) protocol; however, the present application is not limited to the example above.

The signal transmitter 100 includes a driving circuit 110, a control circuit 120, a clamping circuit 130, a terminal resistor RT1 and a pull-down resistor RDN. The driving circuit 110 adjusts a level of a signal pad P1 according to a data signal DP and a data signal DN during a handshake phase to perform a speed negotiation with an electronic device 101. For example, during the handshake phase, the driving circuit 110 may issue a chirp (or pulse) signal according to the data signal DP and the data signal DN to communicate with the electronic device 101. In some embodiments, the electronic device 101 may be a terminal device using the USB protocol. In some embodiments, the driving circuit 110 may be, for example but not limited to, a voltage mode driving circuit. For example, the driving circuit 110 may include a transistor MN1 and a transistor MN2. A first terminal (for example, the drain) of the transistor MN1 receives a power supply voltage AVDD1, a second terminal (for example, the source) of the transistor MN1 is coupled to the signal pad P1 via the terminal resistor RT1, and a control terminal (for example, the gate) of the transistor MN1 receives the data signal DP. A first terminal of the transistor MN2 is coupled to the second terminal of the MN1, a second terminal of the transistor MN2 is coupled to ground, and a control terminal of the transistor MN2 receives the data signal DN. A first terminal of the pull-down resistor RDN is coupled to the terminal resistor RT1 and the signal pad P1, and a second terminal of the pull-down resistor RDN is coupled to ground.

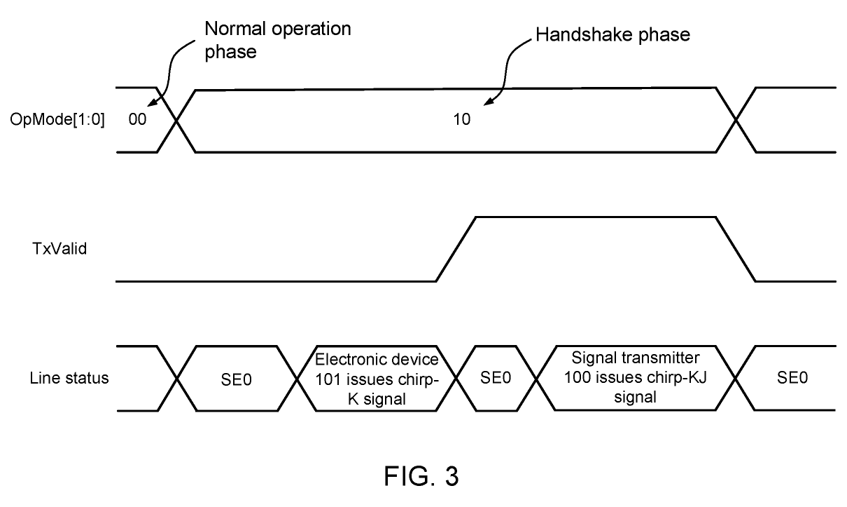

The control circuit 120 generates a clamping signal HSCJ according to an operation mode signal OpMode[1:0] and a transmit valid signal TxValid in the USB protocol. In some embodiments, the USB protocol above may be the USB 2.0 protocol. In some embodiments, the operation mode signal OpMode[1:0] is a 2-bit signal, and is for indicating an operation to be performed by a device. In some embodiments, the transmit valid signal TxValid is for indicating whether a device is transmitting valid data. In some embodiments, the signal transmitter 100 further includes a USB controller, which may generate the operation mode signal OpMode[1:0] and the transmit valid signal TxValid based on the USB protocol. For example, when both of a first bit and a second bit of the operation mode signal OpMode[1:0] are logic 0 (that is, the operation mode signal OpMode[1:0] is 00), it means that the signal transmitter 100 is in a normal operation phase. When the first bit of the operation mode signal OpMode[1:0] is logic 1 and the second bit is logic 0 (that is, the operation mode signal OpMode[1:0] is 10), it means that the signal transmitter 100 is in a handshake phase. During the handshake phase, the electronic device 101 may issue a chirp signal (for example, the chirp-K signal in FIG. 3) to inquire whether the signal transmitter 100 supports high-speed mode signal transmission. If the signal transmitter 100 supports the high-speed mode signal transmission, the signal transmitter 100 may issue an alternating chirp signal (for example, the chirp KJ signal) according to the data signal DP and the data signal DN, such that the electronic device 101 and the signal transmitter 100 may switch to a high-speed mode. Alternatively, if the signal transmitter 100 does not support the high-speed mode, the electronic device 101 and the signal transmitter 100 may keep using full-speed mode data transmission. The operation process during the handshake phase above is equivalent to the speed negotiation described above.

The clamping circuit 130 is activated according to the clamping signal HSCJ during the handshake phase to limit the level of the signal pad P1. During the handshake phase above, when the signal pad P1 is used for transmitting the chirp-J signal, the data signal DP is at a high level (for example, at logic 1) and the data signal DN is at a low level (for example, at logic 0), such that the transistor MN1 is turned on. Meanwhile, in the electronic device 101, an interface circuit connected to the signal pad P1 transmits a power supply voltage AVDD2 via a pull-up resistor RUP, wherein a level of the power supply voltage AVDD2 is higher than a level of the power supply voltage AVDD1. For example, the power supply voltage AVDD2 may be approximately 3.3 V, and the power supply voltage AVDD1 may be approximately 0.8 V. In this case, since the electronic device 101 does not connect its characteristic impedance (that is, the terminal resistor RT2, which may be, for example but not limited to, approximately 45 Ω) to the signal pad P1 (hence depicted in a broken line), the level of the pad P1 increases and an on resistance of the transistor MN1 also increases accordingly. On the other hand, because the power supply voltage AVDD1 and the power supply voltage AVDD2 are divided by the pull-up resistor RUP and the transistor MN1 in the electronic device 101, the level of the signal pad P1 is further increased. Due to influences of actual process variations, the on resistance of the transistor MN1 and the resistance value of the pull-up resistor RUP also fluctuate, such that the level of the signal pad P1 is also subject to influences of the variations above. To prevent any speed negotiation failure caused by an overly high level of the signal pad P1 during the handshake phase, the clamping circuit 130 may be activated according to the clamping signal HSCJ during the handshake phase to reduce the level of the signal pad P1, thereby limiting the level of the signal pad P1 to be within a voltage range defined in the USB protocol.

In some embodiments, the clamping circuit 130 includes a transistor MP1 and a transistor MN3. A first terminal (for example, the source) of the transistor MP1 is coupled to the second terminal of the transistor MN1 and is coupled to the signal pad P1 via the terminal resistor RT1, a second terminal (for example, the drain) of the transistor MP1 is coupled to a first terminal of the transistor MN3, and a control terminal (for example, the gate) of the transistor MP1 receives the clamping signal HSCJ. A second terminal of the transistor MN3 is coupled to ground, and a control terminal of the transistor MN3 is coupled to the first terminal of the transistor MN3. In other words, the transistor MN3 is a diode-connected transistor to operate as a diode, and is coupled between the transistor MP1 and ground. The transistor MP1 may be turned on according to the clamping signal HSCJ to couple the signal pad P1 to ground via the transistor MN3. The configuration details of the clamping circuit 130 above are merely an example, and various configuration forms of the clamping circuit 130 able to achieve the same effect of potential limiting are to be encompassed within the scope of the present application.

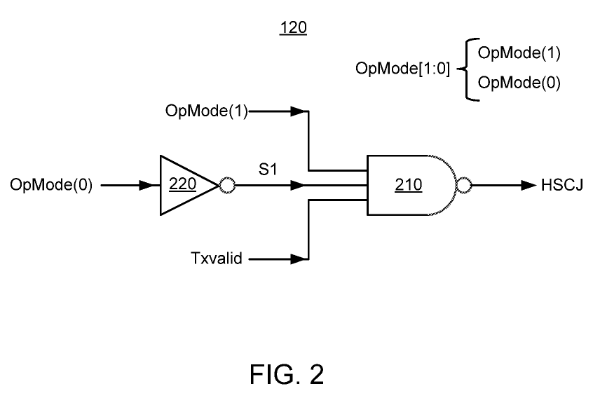

FIG. 2 shows a schematic diagram of the control circuit 120 in FIG. 1 according to an embodiment of the present application. In some embodiments, the control circuit 120 may include a logic gate 210 and an inverter 220. In some embodiments, the logic gate 210 may be, for example but not limited to, a NAND gate. The logic gate 210 generates the clamping signal HSCJ according to the first bit (denoted as OpMode(1)) in the operation mode signal OpMode[1:0], a signal S1 and the transmit valid signal TxValid. The inverter 220 generates the signal S1 according to the second bit (denoted as OpMode(0)) in the operation mode signal OpMode[1:0]. The configuration details of the control circuit 120 above merely an example, and various configuration forms of the control circuit 120 able to perform clamping control based on related control signals in USB specifications during a handshake phase are to be encompassed within the scope of the present application.

FIG. 3 shows a schematic diagram of operation timings of the clamping signal HSCJ and the operation mode signal OpMode[1:0] as well as line statuses between the signal transmitter 100 and the electronic device 101 according to some embodiments of the present application. As shown in FIG. 3, during an initial period, the operation mode signal OpMode[1:0] is 00 (that is, both of the first bit OpMode(1) and the second bit OpMode(0) are logic 0), and the transmit valid signal TxValid is logic 1. In this case, it means that the signal transmitter 100 is in the normal operation phase.

Next, the operation mode signal OpMode[1:0] switches to 10 (that is, the first bit OpMode(1) is logic 1, and the second bit OpMode(0) is logic 0). In this case, the signal transmitter 100 is in the handshake phase, and the speed negotiation starts. Correspondingly, the line status of the signal transmitter 100 switches to single-ended zero (SE0), for example, the data signal DP is at a low level (for example, logic 0) and the data signal DN is at a high level (for example, logic 1), such that the transistor MN2 is turned on and grounded and the level of the signal pad P1 is pulled down accordingly. Once the electronic device 101 detects the state above, the electronic device 101 starts to issue the chirp-K signal. In response to the chirp-K signal, the signal transmitter 100 may again reset the line status to SE0, and the driving circuit 110 may start to issue the chirp-KJ signal based on the data signal DP and the data signal DN. Meanwhile, the transmit valid signal TxValid switches from a low level to a high level, so as to indicate that the signal transmitter 100 is currently issuing valid data signals. In this case, the signal transmitter 100 may notify the electronic device 101 by the chirp-KJ signal above that a high-speed mode may be used for data transmission to complete the speed negotiation.

It is seen from the waveforms above that, once the handshake phase is entered, the operation mode signal OpMode[1:0] switches to 10. Furthermore, when the signal transmitter 100 issues the chirp signal (that is, the chirp-KJ signal) during the handshake phase, the transmit valid signal TxValid switches to a high level corresponding to logic 1. In this case, the control circuit 120 may generate the clamping signal HSCJ in logic 0 to turn on the transistor MP1 in FIG. 1, thereby activating the clamping circuit 130 to limit the level of the signal pad P1. In other words, when the operation mode signal OpMode[1:0] has a predetermined state (that is, 10 described above) and the transmit valid signal TxValid is at a predetermined logical value (for example, logic 1), the clamping circuit 130 may be activated accordingly to limit the level of the signal pad P1. That is, the clamping circuit 130 is activated when the driving circuit 110 issues the chirp signal during the handshake phase. On the other hand, when the operation mode signal OpMode[1:0] does not have the predetermined state or the transmit valid signal TxValid is not at the predetermined logical value, the clamping circuit 130 is not activated so as to avoid any influences upon normal operations of the driving circuit 110.

It should be understood that, the signal transmitter 100 may further include a circuit portion processing another signal pad; for example, the signal pad P1 in FIG. 1 corresponds to pin D+ in a USB interface, and the other signal pad above corresponds to pin D- in the USB interface. The circuit portion is equivalent to the circuit configurations shown in FIG. 1, and such repeated details are omitted herein for brevity.

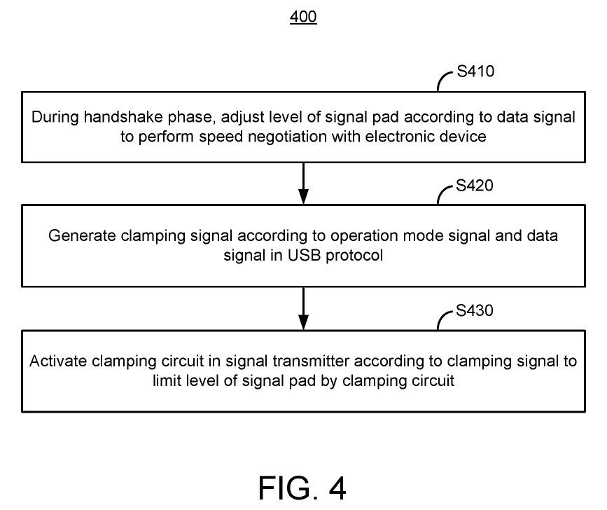

FIG. 4 shows an operation flowchart of a handshake method 400 according to some embodiments of the present application. In some embodiments, the handshake method 400 may be performed by, for example but not limited to, the signal transmitter 100 in FIG. 1. In operation S410, a level of a signal pad is adjusted according to a data signal during a handshake phase to perform a speed negotiation with an electronic device. In operation S420, a clamping signal is generated according to an operation mode signal and a transmit valid signal in a USB protocol. In operation S430, a clamping circuit in the signal transmitter is activated according to the clamping signal during the handshake phase to limit the level of the signal pad by the clamping circuit.

Details associated with the multiple operations of the handshake method 400 above may be referred from the details of the multiple embodiments above, and such repeated details are omitted herein for brevity. The multiple operations above are merely examples, and are not limited to being performed in the order specified in this example. Without departing from the operation means and ranges of the various embodiments of the present application, additions, replacements, substitutions or omissions may be made to the operations of the handshake method 400, or the operations may be performed in different orders. Alternatively, all or some of one or more the operations in the handshake method 400 may be performed simultaneously or partially simultaneously.

In conclusion, the signal transmitter and the handshake method provided according to some embodiments of the present application provide voltage protection during the handshake phase to prevent an erroneous overly high level of a signal pad during the handshake phase, thereby improving the accuracy of negotiation verification during the handshake phase.

While the present application has been described by way of example and in terms of the preferred embodiments, it is to be understood that the disclosure is not limited thereto. Various modifications may be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. A signal transmitter, comprising:
a driving circuit, adjusting a level of a signal pad according to a data signal during a handshake phase to perform a speed negotiation with an electronic device;
a control circuit, generating a clamping signal according to an operation mode signal and a transmit valid signal in a Universal Serial Bus (USB) protocol; and
a clamping circuit, activated according to the clamping signal during the handshake phase to limit the level of the signal pad.

2. The signal transmitter according to claim 1, wherein the control circuit comprises:
a logic gate, generating the clamping signal according to a first bit of the operation mode signal, a first signal and the transmit valid signal; and
an inverter, generating the first signal according to a second bit of the operation mode signal.

3. The signal transmitter according to claim 2, wherein the logic gate is a NAND gate.

4. The signal transmitter according to claim 1, wherein when the operation mode signal has a predetermined state and the transmit valid signal is at a predetermined logical value, the clamping circuit is activated to limit the level of the signal pad.

5. The signal transmitter according to claim 4, wherein when the operation mode signal does not have the predetermined state or the transmit valid signal is not at the predetermined logical value, the clamping circuit is not activated.

6. The signal transmitter according to claim 1, wherein the clamping circuit is activated when the driving circuit issues a chirp signal during the handshake phase to limit the level of the signal pad.

7. The signal transmitter according to claim 1, wherein the clamping circuit comprises:
a first transistor, coupled to the signal pad, and turned on according to the clamping signal; and
a second transistor, coupled between the first transistor and ground, and operating as a diode.

8. A handshake method, performed by a signal transmitter, the handshake method comprising:
adjusting a level of a signal pad according to a data signal during a handshake phase to perform a speed negotiation with an electronic device;
generating a clamping signal according to an operation mode signal and a transmit valid signal in a Universal Serial Bus (USB) protocol; and
activating a clamping circuit in the signal transmitter according to the clamping signal during the handshake phase to limit the level of the signal pad by the clamping circuit.

9. The handshake method according to claim 8, wherein the generating of the clamping signal according to the operation mode signal and the transmit valid signal in the USB protocol comprises:
generating the clamping signal according to a first bit of the operation mode signal, a first signal and the transmit valid signal by a NAND gate in the signal transmitter; and
generating the first signal according to a second bit of the operation mode signal by an inverter in the signal transmitter.

10. The handshake method according to claim 8, wherein the activating of the clamping circuit in the signal transmitter according to the clamping signal during the handshake phase to limit the level of the signal pad by the clamping circuit comprises:
turning on a first transistor in the clamping circuit according to the clamping signal, wherein the first transistor is coupled to the signal pad; and
coupling the first transistor to ground through a second transistor in the clamping circuit, wherein the second transistor operates as a diode.
